(19) United States
(12) Patent Application Publication
(10) Pub. No.: US 2011/0048187 A1
(43) Pub. Date: Mar. 3, 2011

(54) METHOD FOR SLITTING TRANSPARENT POLYMER FILM

(75) Inventor: Kyouhisa UCHIUMI, Minami-Ashigara-shi (JP)

(73) Assignee: FUJIFILM CORPORATION, Tokyo (JP)

(21) Appl. No.: 12/871,679

(22) Filed: Aug. 30, 2010

(30) Foreign Application Priority Data
Aug. 31, 2009 (JP) 2009-200517

(51) Int. Cl. B26D 7/10

(52) U.S. Cl. 83/15; 83/56

(57) ABSTRACT

A method for slitting a continuously traveling laterally-stretched transparent polymer film, comprising the steps of:
heating the transparent polymer film by infrared irradiation; and
slitting the transparent polymer film with a slitting blade.

### BACKGROUND OF THE INVENTION

1. Field of the Invention

The present invention relates to a method for slitting a transparent polymer film, and more particularly, to a method for slitting a continuously traveling laterally-stretched transparent polymer film which is used in the optical field such as a polarizing plate and an optical compensation film.

2. Description of the Related Art

Functional films (functional sheets) such as gas barrier films, protective films, and optical films such as optical filters and antireflection films are used in various devices including optical elements, display devices such as liquid crystal displays and organic EL displays, semiconductor devices, and thin-film solar cells. A functional film (a layered body) where an organic film containing a polymer as the main component is formed on a flexible base material such as a transparent polymer film, and an inorganic film made of an inorganic material is formed thereon as a hard thin film by a vacuum film-forming method is known as one of the functional films.

Most of transparent polymer films used for optical purposes are generally obtained by casting a dope onto a support using a casting die, peeling the dope from the support, and laterally stretching and drying the dope. This method is a typical film production method called solution film-forming method. The obtained film is slit into a predetermined size.

In the slitting process, if the film exhibits poor slittability, cracks may occur in a slit surface, or cutting powder or cutting chips (also referred to as slitting chips below) may be generated and adhere to a slitting blade or a film product portion due to static electricity, wind or the like, to thereby cause a conveyance failure or a product defect. Also, if the film exhibits poor slittability, a slit portion (a portion where slitting is performed) to be the edge of a film product may be deformed, or a product portion may be disconnected.

In the optical field as described above, a stretching process needs to be performed according to the intended use. Stretched polymer films become weak due to the stretching process and thereby exhibit reduced slittability. Thus, there occurs a problem that cutting powder is generated more frequently.

Various proposals have been made to improve slittability. For example, there have been proposed a method for cutting a film by using a cutter in a state in which a portion to be cut in a polymer film is locally heated and kept at a temperature between Tg (the glass transition temperature of a polymer)° C. and (Tg+100)° C. (for example, Japanese Patent Application Laid-Open No. 1-281896), and a method for cutting a film in a state in which a residual volatile content and a temperature during cutting are kept within a predetermined range (for example, Japanese Patent Application Laid-Open No. 9-85680). According to Japanese Patent Application Laid-Open No. 9-85680, it is more preferable to set the residual volatile content to 1 to 15%, and the temperature of a cut portion to 60° C. to Tg (the glass transition temperature of a polymer).

However, none of the above methods can completely suppress the generation of cutting powder (powder generation) as described above. Particularly, a transparent polymer film stretched in the width direction is weak in the longitudinal direction and tears easily in the width direction. Thus, there is a problem that burrs, microcracks, and edge deformation (a slit portion) easily occur.

### SUMMARY OF THE INVENTION

The present invention has been made in view of the above circumstance, and it is an object of the present invention to provide a method for slitting a transparent polymer film, which can suppress the burrs, microcracks, and edge deformation of a transparent polymer film that is stretched in the width direction.

In order to achieve the above object, the present invention provides a method for slitting a continuously traveling laterally-stretched transparent polymer film, including the steps of: heating the transparent polymer film by infrared irradiation; and slitting the transparent polymer film with a slitting blade.

The present inventors have keenly studied a method for suppressing the burrs, microcracks, and edge deformation of a transparent polymer film that is stretched in the width direction, and have found that a quality defect due to the occurrence of burrs, microcracks, and edge deformation can be suppressed by locally heating a portion to be slit (a slit portion) in the transparent polymer film by infrared irradiation, and slitting the transparent polymer film with a slitting blade.

Accordingly, with the present invention, the quality defect due to the occurrence of burrs, microcracks, and edge deformation can be suppressed without changing the physical properties of the transparent polymer film by heating the transparent polymer film by the infrared irradiation, and slitting the transparent polymer film with the slitting blade.

The infrared irradiation is employed since infrared rays have a wavelength close to the absorption wavelength of the transparent polymer film, and the transparent polymer film can be thus preferably heated by the infrared irradiation.

In the present invention, when the transparent polymer film is heated by the infrared irradiation, infrared rays preferably have a wavelength of 0.5 to 2.5 μm. When the present invention is applied to the transparent polymer film, it is preferable to consider the absorption wavelength range of the transparent polymer film. By selecting the wavelength of infrared rays at 0.5 to 2.5 μm, the transparent polymer film can be preferably heated.

In the present invention, when the transparent polymer film is heated by the infrared irradiation, it is preferable that 60° C.≦T≦Tg, wherein Tg (° C.) represents a glass transition temperature of the transparent polymer film, and T (° C.) represents a heating temperature of the transparent polymer film. The quality defect due to the occurrence of burrs, microcracks and edge deformation can be preferably suppressed by heating the transparent polymer film at a temperature within the above range.

In the present invention, a spot size of the infrared irradiation is preferably Φ30 mm or less. When the spot size of the infrared irradiation is Φ30 mm or less, the transparent polymer film can be locally heated, so that adverse effects on a product portion can be eliminated.

In the present invention, the infrared irradiation is preferably performed using a laser.

In the present invention, the transparent polymer film is preferably slit while traveling at a speed of 20 m/min or more. The present invention is particularly effective in a case of performing slitting at a high speed of 20 m/min or more to improve productivity.

With the present invention, the method for slitting a transparent polymer film, which can suppress the burrs, microcracks, and edge deformation of a transparent polymer film that is stretched in the width direction can be provided.

### BRIEF DESCRIPTION OF THE DRAWINGS

FIG. 1 is a schematic view illustrating a film-forming system which employs the present invention;

FIG. 2 is a perspective view schematically illustrating the configuration of a transparent polymer film slitting device; and

FIG. 3 is a schematic view of the transparent polymer film slitting device as viewed from above.

### DETAILED DESCRIPTION OF THE PREFERRED EMBODIMENTS

In the following, a preferred embodiment of a method for slitting a transparent polymer film according to the present invention will be described by reference to the accompanying drawings. Please note that the present invention is not limited to the below embodiment.

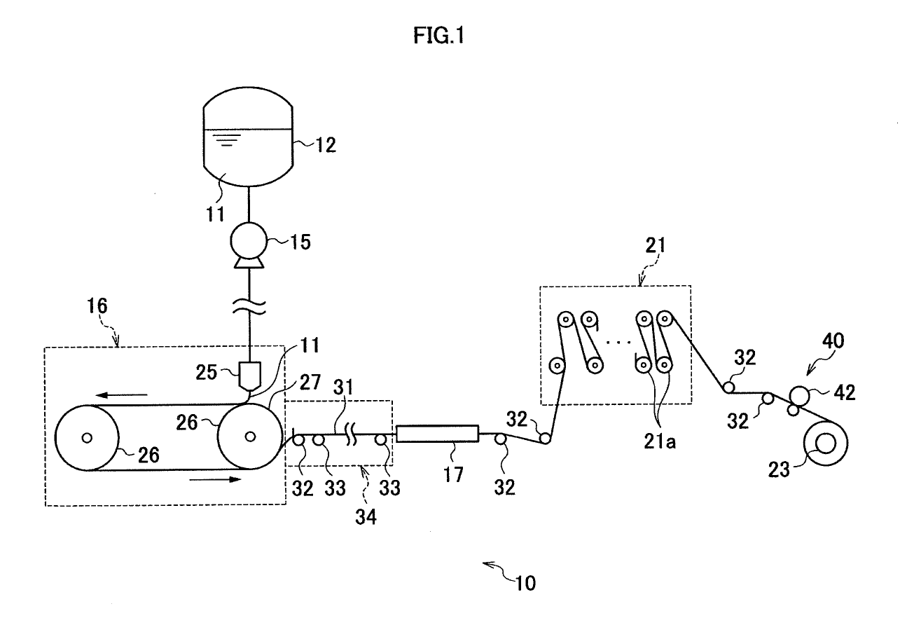

FIG. 1 is a schematic view of a transparent polymer film production system (a solution film-forming system) which employs the present invention. A solution film-forming system 10 includes a reserve tank 12 to which a dope 11 is supplied, a solution feed pump 15, a casting device 16, a tenter device 17, a roller drying device 21, a slitting device 40, and a winding device 23. The casting device 16 includes a casting die 25, and a band 27 as a support to be conveyed while being supported by back-up rollers 26. A peeling roller 32 for peeling a transparent polymer film 31 from the band 27 is also provided on the downstream side of the band 27. A roller 33 is provided on the downstream side of the peeling roller 32 to stably guide the transparent polymer film 31 into the tenter device 17 with the number thereof being increased or decreased as required. Moreover, the rollers 32 and 33 are appropriately determined to be driven or not driven.

The dope 11 is fed to the casting die 25 from the reserve tank 12 by the solution feed pump 15. The casting die 25 casts the dope 11 onto the band 27. The band 27 is continuously conveyed by the back-up rollers 26 which are rotationally driven. The dope 11 is thereby continuously cast thereon. When a self-supporting property develops, the cast dope on the band 27 is peeled as the transparent polymer film 31. The transparent polymer film 31 may be wound around the peeling roller 32 located at the upstream end of a transfer section 34, and continuously peeled by the rotation of the roller 32. Alternatively, the transparent polymer film 31 may be continuously peeled by applying a tension in the conveyance direction of the transparent polymer film 31 from the downstream side of the band 27 by another peeling device or the like. The peeled transparent polymer film 31 is fed to the tenter device 17 through the transfer section 34.

In the tenter device 17, the transparent polymer film 31 is dried while being restricted in width and also being stretched. In the tenter device 17, tenter clips (not shown) travel along a tenter track (not shown) while holding end portions on the both sides of the transparent polymer film 31. The transparent polymer film 31 is conveyed as the tenter clips travel. Pin clips or the like may be used instead of the tenter clips. A controller (not shown) automatically controls the opening and closing of the tenter clips, to thereby hold and release the transparent polymer film 31. The tenter clips holding the transparent polymer film 31 travel inside the tenter device 17, and are automatically controlled to release a holding section and thereby release the transparent polymer film 31 when reaching a predetermined holding release point near an outlet.

The transparent polymer film 31 in the tenter device 17 is fed to the roller drying device 21 where the next process is performed by supporting or conveying rollers 32. The transparent polymer film 31 is sufficiently dried while being supported or conveyed on a plurality of rollers 21a in the roller drying device 21. After that, the both-side end portions (the edges) thereof are slit and removed by a slitting device 40. The slitting device 40 will be described below in detail. FIG. 1 shows only one portion of the slitting device 40. A center portion remaining after slitting is wound as a product by the winding device 23.

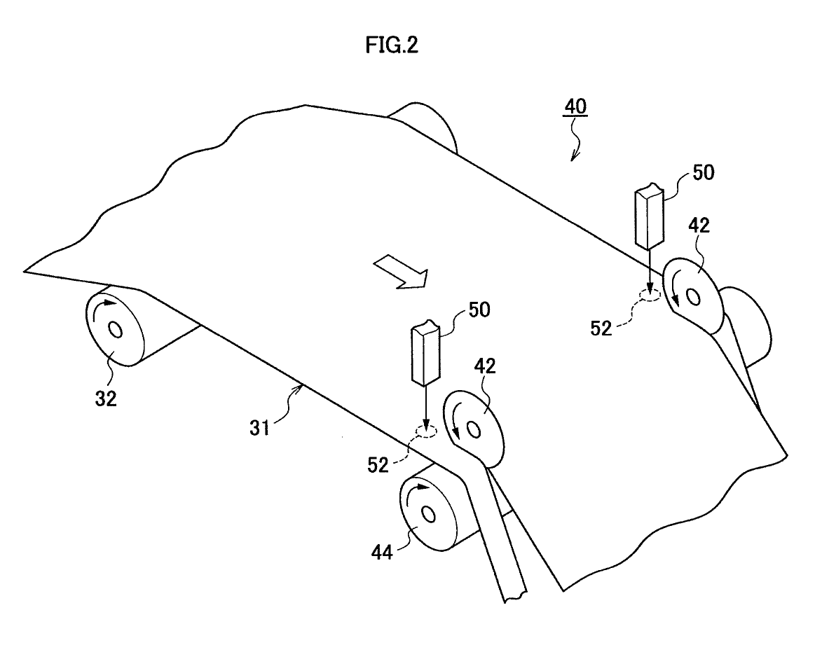

FIG. 2 is a perspective view schematically illustrating an example of the configuration of the transparent polymer film slitting device 40 to which the method for slitting a transparent polymer film according to the present invention is applied. The slitting device 40 shown in FIG. 2 is a device for slitting the long transparent polymer film 31 into a product width. The transparent polymer film 31 is allowed to travel in the direction of the arrow in FIG. 2 by a traveling device such as a feed roller 32. The slitting device 40 is arranged on the upstream side in the traveling direction of the transparent polymer film 31.

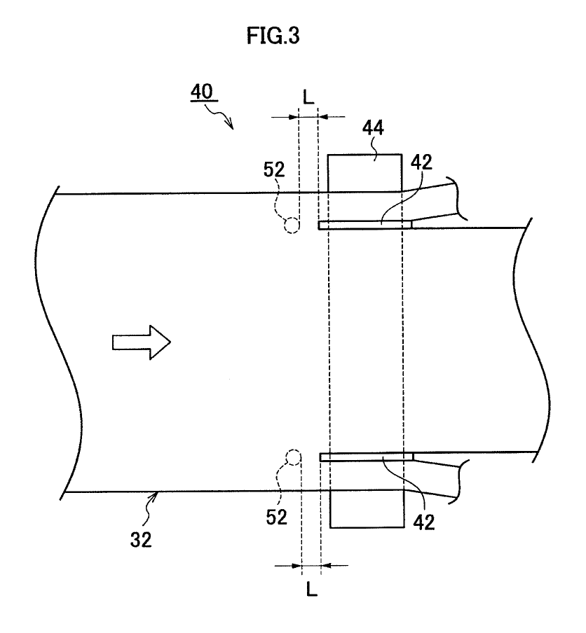

FIG. 3 is a schematic view of the slitting device 40 in FIG. 2 as viewed from above. As shown in FIG. 3, the slitting device 40 includes slitting blades 42. The slitting blades 42 are made of an SK material, an SUS material, or the like. Tungsten carbide or the like is also preferably used.

The slitting blades 42 in FIGS. 2 and 3 are formed in a thin disk shape. The slitting blades 42 may be rotated following the rotation of another member, or rotationally driven by an unillustrated motor. The slitting blades 42 are preferably rotated in the same direction as the traveling direction of the transparent polymer film 31. Although the peripheral speed of the slitting blades 42 is not particularly limited, the slitting blades 42 are set to be rotated at a peripheral speed equal to the traveling speed of the transparent polymer film 31, for example.

When the laterally-stretched transparent polymer film 31 is slit with the slitting blades as described above, burrs, microcracks, and edge deformation (a slit portion) easily occur, to thereby cause a problem of quality defects since the laterally-stretched transparent polymer film is weak in the longitudinal direction and tears easily in the width direction.

Therefore, in the present invention, before the laterally-stretched transparent polymer film 31 is slit with the slitting blades 42 (the circular blades in FIGS. 1 to 3), a portion to be slit in the transparent polymer film 31 is heated by infrared irradiation.

The infrared irradiation is employed since infrared rays have a wavelength close to the absorption wavelength of the transparent polymer film, and the transparent polymer film can be thus preferably heated by the infrared irradiation.

The slitting device 40 in FIGS. 2 and 3 includes an irradiation device 50 which irradiates infrared rays. The irradiation device 50 is provided on the upstream side of the slitting blade 42. A length L between irradiation and slitting is within a range in which the heated temperature is not diffused until the slitting is performed, more specifically, within a range between 1 mm and 100 mm.

According to the present invention, the transparent polymer film is heated by the infrared irradiation, and subsequently slit with the slitting blades. Accordingly, the quality defect due to the occurrence of burrs, microcracks, and edge deformation can be suppressed without changing the physical properties of the transparent polymer film.

The wavelength of infrared rays in performing heating by the infrared irradiation is preferably 0.5 to 2.5 μm. To heat the transparent polymer film, it is preferable to consider the absorption wavelength range of the transparent polymer film. For example, in a case where the transparent polymer film is TAC (cellulose triacetate), the TAC has an absorption wavelength at around 5.7 μm, 8.0 and 9.5 μm. The wavelength of infrared rays is preferably shorter than the absorption wavelength of the transparent polymer film in consideration of the size of the infrared irradiation device which irradiates infrared rays and the energy density of the infrared irradiation. Thus, by selecting the wavelength of infrared rays at 0.5 to 2.5 μm, the transparent polymer film can be preferably heated.

The heating by the infrared irradiation preferably has a relationship of 60° C.≦T≦Tg, wherein Tg (° C.) represents the glass transition temperature of the transparent polymer film, and T (° C.) represents the heating temperature thereof. The quality defect due to the occurrence of burrs, microcracks, and edge deformation can be preferably suppressed by slitting the transparent polymer film after heating at a temperature within the above range.

A spot size 52 of the infrared irradiation is preferably Φ30 mm or less. When the spot size 52 of the infrared irradiation is Φ30 mm or less, the transparent polymer film can be locally heated, so that adverse effects on a product portion can be eliminated.

The irradiation device 50 is preferably a laser. However, any device such as a halogen spot heater may be employed as long as the spot size 52 of the infrared irradiation can be reduced.

Also, in the present invention, the transparent polymer film preferably travels at a speed of 20 m/min or more to be slit. The burrs, microcracks, and edge deformation particularly easily occur when the transparent polymer film is slit at a high speed of 20 m/min or more to improve productivity. Thus, it is effective to heat the portion to be slit in the transparent polymer film 31 by the infrared irradiation before slitting the transparent polymer film 31 with the slitting blades 42 as in the present invention.

Although the present embodiment is described based on the example of the transparent polymer film produced by the solution film-forming method, a transparent polymer film produced by a melt film-forming method may be also similarly applied thereto. That is, in both the cases of using the transparent polymer film produced by the solution film-forming method, and the transparent polymer film produced by the melt film-forming method, the quality defect due to the burrs, microcracks, and edge deformation can be suppressed by heating the portion to be slit in the laterally-stretched transparent polymer film 31 by the infrared irradiation before slitting the transparent polymer film 31 with the slitting blades 42.

Examples of a polymer capable of producing the effect of the slit state of the transparent polymer film according to the present invention include various cellulose acylates such as TAC, various polyesters such as polyethylene terephthalate (PET) and polyethylene-2,6-naphthalate (PEN), various polyolefins such as polyethylene (PE), polystyrene, polyvinyl chloride (PVC), polyvinylidene chloride, polycarbonate (PC), polyamide (PA), and polyimide (PI). In the case of polyimide, a solution of polyamic acid as a precursor is cast, a solvent is removed by heating and drying the polyamic acid solution, and a film of polyimide is obtained by cross-linking. The film may be slit before or after the entire film is completely cross-linked. Among the above examples, the TAC produces the best effect.

### EXAMPLES

Next, examples of the present invention will be described. A transparent polymer film was produced by using the solution film-forming system 10 in FIG. 1. In the following description, the composition and preparation method in the preparation of a polymer solution (a dope) will be described first, and the method for producing a film, the property evaluation of the obtained film, and the results thereof will be subsequently described. Lastly, the cutting conditions or the like by the slitting device 40 according to the slitting method of the present invention will be described.

### [Dope Composition]

Cellulose triacetate (powder having a substitution degree of 2.84, a viscosity average polymerization degree of 306, a water content of 0.2 mass %, a viscosity of 315 mPa·s at 6 mass % in a dichloromethane solution, and an average particle size of 1.5 mm with a standard deviation of 0.5 mm): 100 parts by mass

Dichloromethane (first solvent): 320 parts by mass

Methanol (second solvent): 83 parts by mass

1-Butanol (third solvent): 3 parts by mass

Optical characteristic-controlling agent: 1.0 parts by mass

UV agent a: 2(2′-Hydroxy-3′,5′-di-tert-butylphenyl)benzotriazole: 0.7 parts by mass

UV agent b: 2(2′-Hydroxy-3′,5′-di-tert-amylphenyl)-5-chlorobenzotriazole: 0.3 parts by mass

Citric acid ester mixture (mixture of citric acid, citric acid monoethyl ester, citric acid diethyl ester, and citric acid triethyl ester): 0.006 parts by mass

Fine particles (silicon dioxide (particle size: 15 nm), Mohs hardness: about 7): 0.05 parts by mass

Dye (dye example: chemical-115(I-4)): 0.0005 parts by mass

### [Cellulose Triacetate]

Cellulose triacetate used herein had a residual acetic acid amount of 0.1 mass % or less, a Ca content of 58 ppm, an Mg content of 42 ppm, an Fe content of 0.5 ppm, a free acetic acid content of 40 ppm, and a sulfate ion content of 15 ppm. The substitution degree of an acetyl group at the 6-position was 0.91, which was 32.5% of the entire acetyl. The acetone extraction obtained by extracting the TAC with acetone was 8 mass %, and the weight-average molecular weight/number average molecular weight was 2.5. The obtained TAC had a yellow index of 1.7, a haze of 0.08, a transparency of 93.5%, a Tg (a glass transition temperature; measured by DSC) of 160° C., and a crystallization calorific value of 6.4 J/g. The TAC was synthesized by using, as a raw material, cellulose obtained from cotton. In the following description, the TAC is referred to as cotton raw material TAC.

### (1) Preparation of Dope

A dope was prepared by using a dope preparing device. The above plurality of solvents were mixed and stirred well to obtain a mixed solvent in a 4000L stainless-steel dissolution tank having a stirring blade. All the solvents used herein had a water content of 0.5 mass % or less. Subsequently, TAC powder (flaky powder) was gradually added from a hopper of the dissolution tank. The TAC powder was put into the dissolution tank, and dispersed for 30 minutes under predetermined conditions by a dissolver-type eccentric stirrer having an anchor blade on the rotating shaft. The initial dispersion temperature was 25° C., and the final peak temperature was 48° C. Moreover, a preliminarily prepared additive solution was fed to the dissolution tank from an additive tank with the solution feed amount being adjusted using a valve, so that the dope had a total amount of 2000 kg. After the completion of dispersion of the additive solution, the high-speed stirring was stopped. By setting the peripheral speed of the anchor blade to a predetermined speed, stirring further continued for 100 minutes. The TAC flake was thereby swollen to obtain a swollen solution. The inside of the tank was pressurized to 0.12 MPa by a nitrogen gas until the swelling was completed. At this time, the oxygen concentration inside the dissolution tank was less than 2 vol %, which means the dissolution tank maintained an acceptable state in view of explosion protection. The water content in the swollen solution was 0.3 mass %.

### (2) Dissolution and Filtration

The swollen solution was fed to a jacketed pipe from the dissolution tank by using a pump. The swollen solution was heated to 50° C. in the jacketed pipe, and further heated to 90° C. under a pressure of 2 MPa, so that the swollen solution was completely dissolved. The heating time was 15 minutes. Subsequently, the dissolved solution was cooled to 36° C. by a temperature controller, and allowed to pass through a filtering device having a filtering member with a nominal pore size of 8 μm, to thereby obtain a dope (referred to as pre-concentrated dope below). At this point, the primary pressure in the filtering device was 1.5 MPa, and the secondary pressure therein was 1.2 MPa. As for the filter, housing and pipe exposed to high temperature, those made of hastelloy alloy, excellent in corrosion resistance, and having a heating and insulating jacket for circulating a heat-transfer medium were used.

### (3) Concentration, Filtration, Defoaming, and Additive

The pre-concentrated dope obtained as described above was flash-evaporated within a flash device at 80° C. under an atmospheric pressure. The evaporated solvent was condensed and recovered by a condenser. The solid content concentration of the dope after flashing was 21.8 mass %. The condensed solvent was reproduced in a reproducing device after being recovered by a recovering device, and was fed to a solvent tank so as to be reused as a dope preparing solvent. The recovering device and the reproducing device performed distillation, dehydration and the like. A stirrer having an anchor blade on the stirring shaft was provided in a flash tank of the flash device. The anchor blade was rotated at a predetermined peripheral speed, and the flashed dope was thereby stirred to perform defoaming. The temperature of the dope in the flash tank was 25° C. The average residence time of the dope in the tank was 50 minutes. The shear viscosity measured at 25° C. by collecting the dope was 450 Pa·s at a shear speed of 10 (sec−1).

The dope was subsequently defoamed by applying a weak ultrasonic wave thereto. The dope then passed through a filtering device while being pressurized to 1.5 MPa by using a pump. In the filtering device, the dope first passed through a sintered metal fiber filter with a nominal pore size of 10 μm, and then through a sintered fiber filter with the same nominal pore size of 10 μm. The primary pressures thereof were 1.5 MPa, and 1.2 MPa, respectively, and the secondary pressures thereof were 1.0 MPa, and 0.8 MPa, respectively. The dope 11 was fed into a 2000L stainless-steel stock tank with the temperature of the dope after filtration being adjusted to 36° C., and was stored therein. The stock tank had a stirrer having an anchor blade on the center shaft, and stirred the dope using the stirrer. Problems such as corrosion did not occur in a dope-contact portion from when the pre-concentrated dope was obtained until when the dope 11 was prepared.

Also, a mixed solvent A having 86.5 parts by mass of dichloromethane, 13 parts by mass of acetone, and 0.5 parts by mass of 1-butanol was prepared.

### (4) Discharge, Immediately-Before Addition, Casting, and Bead Decompression

A film was produced by using the solution film-forming system 10 shown in FIG. 1. The dope 11 in the reserve tank 12 was fed to a filtering device by the accurate gear pump 15. The pump 15 had a function of increasing the pressure on the primary side of the pump 15. The dope 11 was fed by performing feedback control on the upstream side of the pump 15 by an inverter motor such that the primary pressure reached 0.8 MPa. As for the performance of the pump 15, the volume efficiency was 99.2% and the discharge rate variation was 0.5% or less. The discharge pressure thereof was 1.5 MPa. The dope 11 passing through the filtering device was fed to the casting die 25.

The casting die 25 performed casting by adjusting the flow rate of the dope 11 at a discharge port of the die 25 such that the dried film 31 having a width of 1.8 m had a thickness as shown in Tables 1 and 2 below. The casting width of the dope 11 from the discharge port of the die 25 was set to 1700 mm. To adjust the temperature of the dope 11 to 36° C., a jacket (not shown) was provided in the casting die 25, and the inlet temperature of a heat-transfer medium supplied into the jacket was set to 36° C.

The casting die 25 and the pipe were all kept at 36° C. during operation. The casting die 25 was a coat hanger type die. A die including an automatic thickness adjusting mechanism using a heat bolt where thickness adjusting bolts were provided at a pitch of 20 m was used as the die 25. The heat bolt had a function of setting a profile corresponding to the solution feed rate of the pump 15 by a program set in advance, and also performing feedback control by an adjustment program based on the profile of an infrared thickness gauge (not shown) installed in the solution film-forming system 10. In the film excluding 20 mm of a casting edge portion, the thickness difference between any two points apart from each other by 50 mm was adjusted to 1 μm or less, and the thickness variation in the width direction was adjusted to 3 μm or less. Also, the entire thickness was adjusted to ±1.5% or less.

A decompression chamber was also installed on the primary side of the casting die to decompress the portion. The decompression degree of the decompression chamber was adjusted to generate a pressure difference of 1 Pa to 5000 Pa between the upstream side and downstream side of a casting bead. The adjustment was performed corresponding to the casting speed. At this point, the pressure difference between the both surface sides of the bead was set such that the bead had a predetermined length. The decompression chamber also had a mechanism capable of setting the temperature higher than the condensation temperature of a gas near the casting section. Labyrinth seals (not shown) were provided in a front surface portion and a back surface portion of the bead at the die discharge port, and opening portions were also provided at the both ends of the die discharge port. An edge suction device (not shown) for eliminating irregularity in the both edges of the casting bead was further attached to the die.

### (5) Casting Die

The casting die 25 was made of material precipitation hardened stainless steel having a thermal expansion coefficient of 2×10⁻⁵ (° C.⁻¹) or less. The material precipitation hardened stainless steel was a material having corrosion resistance almost equivalent to that of SUS316 in an accelerated corrosion test in an electrolyte aqueous solution. The corrosion resistance thereof was good enough not to generate pitting (holes) in a gas-liquid interface even when the material was immersed in a mixture of dichloromethane, methanol and water for three months. The finishing accuracy of the solution-contact surface of the casting die 25 was adjusted such that the surface roughness was 1 μm or less, the straightness was 1 μm/m or less in any direction, and the slit clearance was 1.5 mm. A corner portion of the solution-contact portion at the distal end of a lip of the die 25 was processed such that R was 50 μm or less over the entire width. The shear speed inside the die was in a range of 1 (1/sec) to 5000 (1/sec). A hardened film was provided at the distal end of the lip of the casting die 25 by applying a WC (tungsten carbide) coating by a thermal spraying method.

The mixed solvent A for solubilizing the dope 11 was further supplied to an interface portion between each side end portion of the casting bead and the discharge port of the casting die 25 by 0.5 ml/min each to prevent the dope 11 flowing out from the discharge port from being locally dried and solidified. A pump supplying the mixed solvent A had a pulsation of 5% or less. The pressure on the back surface side of the bead was set lower than that on the front surface side by 150 Pa by the decompression chamber. A jacket (not shown) for making the inner temperature of the decompression chamber constant at a predetermined temperature was also attached. A heat-transfer medium adjusted to 35° C. was supplied into the jacket. The edge suction device can adjust the edge suction air volume to a range of 1 L/min to 100 L/min, and the edge suction air volume was appropriately adjusted to a range of 30 L/min to 40 L/min in the present embodiment.

(6) Metal support

A stainless-steel endless band having a width of 2.1 m and a length of 70 m was used as the casting band 27 as the support. The casting band 27 was polished to a thickness of 1.5 mm and a surface roughness of 0.05 μm or less. The casting band 27 was made of SUS316 having enough corrosion resistance and strength. The entire thickness variation of the casting band 27 was 0.5% or less. The casting band 27 was conveyed by the two back-up rollers 26. The relative speed difference between the casting band 27 and the back-up rollers 26 was adjusted to 0.01 m/min or less such that the tension of the casting band 27 in the conveyance direction during conveyance had a predetermined value. The speed variation of the casting band 27 was 0.5% or less. The both end positions of the casting band 27 were detected to control the casting band 27 such that the meandering in the width direction of the casting band 27 during one rotation was limited to 1.5 mm or less. The vertical position variation between the distal end of the die lip and the casting band 27 just under the casting die was limited to 200 μm or less. The casting band 27 was installed within a casting chamber (not shown) having an air pressure variation suppressing device (not shown). The dope 11 was cast onto the casting band 27 from the casting die 25.

A roller into which a heat-transfer medium can be fed was used as the back-up roller 26 to control the temperature of the casting band 27. A heat-transfer medium of 5° C. was circulated in the back-up roller 26 on the casting die 25 side. A heat-transfer medium of 40° C. was circulated in the other back-up roller 26 for drying. The surface temperature of a center portion of the casting band 27 immediately before casting was 15° C., and the temperature difference between the both side ends was 6° C. or less. The casting band 27 preferably had no surface defect, and a band having no pinhole with a diameter of 30 μm or more, 1/m² or less pinhole with a diameter of 10 to 30 and 2/m² or less pinholes with a diameter of less than 10 μm was used.

### (7) Casting and Drying

The temperature of the casting chamber was kept at 35° C. by using a temperature control system. First, drying air flowing parallel to a casting film formed from the dope 11 cast onto the casting band 27 was fed to the casting film to thereby dry the casting film. The overall heat transfer coefficient from the drying air to the casting film was 24 kcal/m²·hr·° C. The drying air was blown from an air blower (not shown) at a temperature of 135° C. on the upstream side, and 140° C. on the downstream side in an upper portion of the casting band 27, and also, at a temperature of 65° C. in a lower portion of the casting band 27. The saturation temperature of each drying air was around −8° C. The oxygen concentration in a dry atmosphere on the casting band 27 was kept at 5 vol %. To keep the oxygen concentration at 5 vol %, a nitrogen gas was substituted for air. A condenser was also provided to condense and recover the solvent inside the casting chamber, and the outlet temperature was set to −10° C.

The drying air was prevented from directly striking the dope 11 and the casting film by an air blocking device for 5 seconds after casting, to thereby suppress the static pressure variation close to the casting die 25 to ±1 Pa or less. When the solvent ratio in the casting film reached 50 mass % on a dry basis, the dope was peeled as the film 31 from the casting band 27 while being supported on the peeling roller. The solvent content ratio on a dry basis is a value obtained by {(y1-y2)/y2}×100, wherein y1 represents the film weight in sampling, and y2 represents the weight after drying the sampling film. The peeling tension at this time was controlled to a predetermined value, and the peeling speed relative to the speed of the casting band 27 (peeling roller draw) was appropriately adjusted within a range of 100.1% to 110% to suppress a peeling failure. The surface temperature of the peeled film was 15° C. The average drying speed on the casting band 27 was 60 mass % (dry basis solvent)/min. A solvent gas generated by drying was condensed into a liquid by a condenser of −10° C. and recovered by a recovering device (not shown). The recovered solvent was adjusted to a water content of 0.5% or less. The drying air from which the solvent was removed was heated again and reused as drying air. The film 31 was conveyed via the rollers and fed to the tenter device 17. At the time of conveying the film 31, drying air of 40° C. was fed to the film 31 from the air blower (not shown). A predetermined tension was applied to the film 31 while the film is being conveyed on the rollers in the transfer section.

### (8) Tenter Conveyance and Drying

The film 31 fed to the tenter device 17 was conveyed through a drying zone of the tenter device 17 with the clips fixing the both ends thereof, and dried by drying air during the conveyance. The clips were cooled by supplying a heat-transfer medium of 20° C. The clips were conveyed in the tenter device 17 by using a chain, and the speed variation of the sprocket of the chain was 0.5% or less. The temperature in the tenter device 17 was 140° C. The gas composition of the drying air was that of saturated gas concentration at −10° C. The average drying speed inside the tenter device 17 was 120 mass % (dry basis solvent)/min. The conditions of the drying zone were adjusted such that the residual solvent amount of the film 31 at the outlet of the tenter device 17 was 7 mass %. The tenter device 17 stretched the film 31 in the width direction while conveying the film 31 except in Experiment 1 in Table 1 described below. When the width of the film 31 before stretching was taken as 100%, the film 31 was stretched to a width of 103%. The stretching ratio (tenter drive draw) from the peeling roller 32 to the inlet of the tenter device 17 was 102%. The stretching ratio inside the tenter device 17 was controlled to a predetermined value. The ratio of the length between a clip holding start position and a holding release position relative to the length between the inlet and the outlet of the tenter was 90%. The solvent evaporated in the tenter device 17 was condensed into a liquid at a temperature of −10° C. and thereby recovered. A condenser was provided for condensation recovery, and the outlet temperature was set to −8° C. The condensed solvent was reused by adjusting the water content therein to 0.5 mass % or less.

### (9) Post-Drying

The film 31 was dried at a high temperature by the roller drying device 21. The roller drying device 21 was sectioned into four sections, and respective drying air of 120° C., 130° C., 130° C., and 130° C. was supplied from an air blower (not shown) to the four sections in a sequence from the upstream side. The conveying tension of the film 31 by the roller 21a was controlled to a predetermined value. The film 31 was dried for about 10 minutes until the residual solvent amount finally reached 0.3 mass %. The wrap angle around the roller 21a (the film winding center angle) was 90° and 180°. The roller 21a was made of aluminum or carbon steel. Hard chrome plating was applied to the surface. A flat type and a matted type by blasting were used as the surface shape of the roller 21a. The position displacements of the film due to the rotation of the roller 21a were all 50 μm or less. The deflection of the roller 21a after the tension was applied thereto was set to 0.5 mm or less.

The solvent gas contained in the drying air was absorbed, recovered, and removed by using an absorption recovering device (not shown). The absorbent used herein was activated carbon, and desorption was performed using dry nitrogen. The recovered solvent was reused as a dope preparing solvent by adjusting the water content to 0.3 mass % or less. The drying air contained a plasticizer, a UV absorbent, and other high-boiling substances besides the solvent gas. Thus, these substances were removed by a cooler and a preadsorber for cooling and removing the substances, to thereby reproduce and recycle the drying air. The absorption and desorption conditions were set such that VOC (a volatile organic compound) in an outdoor discharge gas was finally 10 ppm or less. The solvent amount recovered by the condensation method was 90 mass % of the entire evaporated solvent, and the remaining solvent was also mostly recovered by the absorption recovery.

The dried film 31 was conveyed to a first moisture control chamber (not shown). Drying air of 110° C. was fed to a transfer section between the roller drying device 21 and the first moisture control chamber. Air having a temperature of 50° C. and a dew point of 20° C. was fed to the first moisture control chamber. The film 31 was further conveyed to a second moisture control chamber (not shown) to suppress the occurrence of curling of the film 31. In the second moisture control chamber, air having a temperature of 90° C. and a humidity of 70% was brought into direct contact with the film 31.

### (10) Knurling, Edge Cutting and Winding Conditions

The moisture-controlled film 31 was cooled to 30° C. or less in a cooling chamber, and then, the edges thereof were cut by the slitting device 40. The edges of the film 31 were cut by the slitting device 40 within 30 seconds after passing through the outlet of the cooling chamber. As the slitting conditions, the diameters of the slitting blade 42 and a cylindrical roller 44 were set to Φ150 respectively, the thickness of the slitting blade 42 was set to 1.0 mm, and the peripheral speeds of the slitting blade 42 and the cylindrical roller 44 were set to be the same as the processing speed. Other slitting conditions are described in Tables 1 and 2 below. A forced neutralization device (a neutralization bar) was installed to control the electric charge of the film 31 during conveyance to a range of −3 kV to +3 kV at all times. Knurling was applied to the both ends of the film 31 by a knurling roller. The knurling was applied by performing embossing from one surface side of the film 31. The width to which the knurling was applied was 10 mm. The pressing force of the knurling roller was set such that a raised portion was higher than the average thickness of the film 31 by an average of 12 μm.

The film 31 was then conveyed to the winding device 23. The winding device 23 was kept at a device internal temperature of 28° C., and a humidity of 70%. Moreover, an ionized air neutralization device (not shown) was installed inside the winding device 23 to control the electric charge of the film 31 to −1.5 kV to +1.5 kV. The product width of the film (having a thickness of 92 μm) 31 obtained as described above was 1475 mm. The diameter of a winding roller of the winding device 23 was 169 mm. The tension was controlled to a predetermined value respectively at a winding start and a winding end. The entire length of the wound film 31 was 3940 mm. The variation width of the winding displacement during winding (also referred to as oscillation width) was ±5 mm. The cycle of the winding displacement relative to the winding shaft was 400 m. The pressing force of a press roller on the winding shaft was controlled to a predetermined value. The temperature of the film 31 in winding was 25° C., the water content was 1.4 mass %, and the residual solvent amount was 0.3 mass %. The average drying speed throughout the entire processes was 20 mass % (dry basis solvent)/min.

### (11) Evaluation

A method of evaluating the obtained sample is described below.

### [Burr]

The sample was observed with a stereoscopic microscope×50, and whether the sample adhered to the blade edge was further evaluated. If the sample adheres to the blade edge, the blade sharpness significantly degrades.

A: One linearly cut, and thus, with no edge being separated nor likely to be separated

B: One with no edge being separated

C: One with some edges being separated but no practical problem being caused

D: One with edges being separated to be possibly mixed into a product

### [Crack]

The sample was observed with an optical microscope×500. Cracks are a critical problem since the cracks can cause disconnection especially in a film strongly stretched in the width direction.

A: One with no crack at an end portion

B: One with cracks at an end portion but no edge being separated

C: One with some edges being separated from cracks but no practical problem being caused

D: One with edges being separated from cracks to be possibly mixed into a product

### [Edge Deformation]

The edge may become a seaweed-like shape due to thermal deformation.

A: Not deformed

B: Deformed, but small enough not to affect sharpness

D: Deformed large enough to affect sharpness

### (12) Experiments and Results

Experiment conditions (Experiments 1 to 14) and results are shown in Tables 1 and 2.

In Experiments 1 to 4 in Table 1, the transparent polymer film was slit without being heated before slitting. Only the transparent polymer film in Experiment 1 was not laterally stretched (unstretched). Therefore, the transparent polymer film had a room temperature.

In Experiments 5 to 14 in Table 2, the transparent polymer film was slit after being heated as shown in FIGS. 2 and 3. Heating was performed by a laser in Experiments 5 to 10, a halogen spot heater in Experiments 11 to 13, and air in Experiment 14. The halogen spot heater HSH-30 manufactured by Fintech Co., Ltd. was used as the halogen spot heater, and the experiments were conducted by changing the frequency. To be more specific, the laser was a YAG laser (wavelength: 1.064 μm) with a spot size of Φ0.1 mm, and the halogen spot heater had a spot size of Φ30.0 mm, and a wavelength of 1.000 μm in Experiment 10, 0.500 μm in Experiment 11, and 2.500 μm in Experiment 12. The heating range using air was wide.

TABLE 1

| | Film | | Processing | | Evaluation | | |
|---|---|---|---|---|---|---|---|
| | | Thickness | speed | | | | Edge |
| | Base material | (μm) | (m/min) | Heating | Burr | Crack | deformation |
| Experiment 1 | TAC | 80 | 50 | No | B | B | B |
| Experiment 2 | Laterally- | 80 | 15 | No | C | C | B |
| | stretched TAC | | | | | | |
| Experiment 3 | Laterally- | 80 | 20 | No | C | D | B |
| | stretched TAC | | | | | | |
| Experiment 4 | Laterally- | 80 | 30 | No | D | D | B |
| | stretched TAC | | | | | | |

TABLE 2

| | Film | | Processing | Heating/ | Evaluation | | |
|---|---|---|---|---|---|---|---|
| | | Thickness | speed | Temperature | | | Edge |
| | Base material | (μm) | (m/min) | (° C.) | Burr | Crack | deformation |
| Experiment 5 | Laterally- | 80 | 30 | Laser/100 | A | A | A |
| | stretched TAC | | | | | | |
| Experiment 6 | Laterally- | 80 | 30 | Laser/150 | B | A | A |
| | stretched TAC | | | | | | |
| Experiment 7 | Laterally- | 80 | 30 | Laser/60 | B | B | B |
| | stretched TAC | | | | | | |
| Experiment 8 | Laterally- | 40 | 30 | Laser/100 | B | B | A |
| | stretched TAC | | | | | | |
| Experiment 9 | Laterally- | 40 | 50 | Laser/100 | B | B | A |
| | stretched TAC | | | | | | |
| Experiment 10 | Laterally- | 40 | 20 | Laser/100 | A | B | A |
| | stretched TAC | | | | | | |
| Experiment 11 | Laterally- | 80 | 30 | Halogen/90 | A | A | B |
| | stretched TAC | | | | | | |
| Experiment 12 | Laterally- | 80 | 30 | Halogen/90 | A | A | B |
| | stretched TAC | | | | | | |
| Experiment 13 | Laterally- | 80 | 30 | Halogen/90 | A | A | B |
| | stretched TAC | | | | | | |
| Experiment 14 | Laterally- | 80 | 30 | Air/100 | B | C | D |
| | stretched TAC | | | | | | |

As seen from Table 1, when the laterally-stretched transparent polymer film (the laterally-stretched TAC) is slit, burrs and cracks easily occur. Also, as the speed of the transparent polymer film to be slit is faster, the occurrence state of burrs and cracks is deteriorated. Especially when the laterally-stretched TAC traveling at 20 m/min or more is slit, the state is significantly deteriorated.

Meanwhile, as seen from Table 2, those where the portion to be slit in the laterally-stretched transparent polymer film is slit after being heated by infrared irradiation are evaluated as B or better regarding burr and crack. That is, unlike in Table 1, even when the laterally-stretched TAC traveling at 20 m/min or more is slit, burrs, microcracks, and edge deformation are suppressed.

The results show that the present invention can suppress the burrs, microcracks, and edge deformation of the transparent polymer film stretched in the lateral (width) direction.

What is claimed is:

1. A method for slitting a continuously traveling laterally-stretched transparent polymer film, comprising the steps of:
heating the transparent polymer film by infrared irradiation; and
slitting the transparent polymer film with a slitting blade.

2. The method for slitting a transparent polymer film according to claim 1, wherein when the transparent polymer film is heated by the infrared irradiation, infrared rays have a wavelength of 0.5 to 2.5 μm.

3. The method for slitting a transparent polymer film according to claim 1, wherein when the transparent polymer film is heated by the infrared irradiation,
60° C.≦T≦Tg, wherein Tg (° C.) represents a glass transition temperature of the transparent polymer film, and T (° C.) represents a heating temperature of the transparent polymer film.

4. The method for slitting a transparent polymer film according to claim 1, wherein a spot size of the infrared irradiation is Φ30 mm or less.

5. The method for slitting a transparent polymer film according to claim 1, wherein the infrared irradiation is performed using a laser.

6. The method for slitting a transparent polymer film according to claim 1, wherein the transparent polymer film is slit while traveling at a speed of 20 m/min or more.
